(19) United States
(12) Patent Application Publication
(10) Pub. No.: US 2016/0188821 A1
(43) Pub. Date: Jun. 30, 2016

(54) SYSTEM AND METHOD FOR AGGREGATION AND INTELLIGENT ANALYSIS OF INDIVIDUAL HEALTH DATA WITH MULTIMODAL COMMUNICATION

(71) Applicant: Larry Ozeran, Yuba City, CA (US)

(72) Inventor: Larry Ozeran, Yuba City, CA (US)

(21) Appl. No.: 14/583,035

(22) Filed: Dec. 24, 2014

(51) Int. Cl. G06F 19/00

(52) U.S. Cl. CPC G06F 19/345; G06F 19/322

(57) ABSTRACT

A system and method for aggregation and intelligent analysis of individual health data with multimodal communication are disclosed. A particular embodiment includes the following: generating a care plan associated with a person, the care plan including at least one rule defining an action to be performed if at least one of a plurality of metrics is not timely received or if at least one of the plurality of metrics is outside of pre-defined limits; collecting and aggregating the plurality of metrics associated with the person, the plurality of metrics being collected by explicit entry by the person or automatically captured by a sensor associated with the person; providing support to the person in adhering to the care plan; and performing the action based on the care plan, the action including automatically sending a notification to at least one of a hierarchy of pre-defined recipients by one or more methods of communication.

### TECHNICAL FIELD

This patent application relates to data processing hardware, computer-implemented software, and networked systems, according to one embodiment, and more specifically to a system and method for aggregation and intelligent analysis of individual health data with multimodal communication.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2014 Clinical Informatics, Inc., All Rights Reserved.

### BACKGROUND

Electronic information processing and communication systems are playing an increasingly important role in coordinating the administration and delivery of healthcare to patients in cooperation with various members of a community and also in supporting the desire of well persons who wish to maintain optimal health. Among other functions, these technologies may be utilized for coordinating administrative operations, disseminating information or documents for review and retention, providing individual access to medical and wellness information, providing access to social support, creating games and reward systems, and providing reference and research libraries. Currently, these activities are not available in a coordinated manner. In addition, many vital services and activities as well as important health information and patient records are not available in a simplified and automated way.

The collection of individual health data from multiple sources is a challenge in today's healthcare environment. This inability to conveniently and instantly gather individual health data limits personal knowledge about a person's health and impedes optimal care when healthcare providers are unaware of the care provided by others. It further impedes the ability of the person and their family to optimally support the care management process and to use the data to support the goals of a wellness program (wellness goals).

In the current healthcare environment, there is no single source of a person's complete health status. Healthcare is typically provided episodically. There is limited capacity to find a complete health history to enable performance of a comprehensive, real-time assessment of a person's current health status. As a result, individuals with chronic disease can become exceedingly ill before costly intervention is taken to reverse their health deterioration. Providing timely, less expensive interventions are likely to also be more effective than delayed, more costly interventions.

Individuals living alone do not always have the support of friends and family to promote optimal safety and health. This social isolation is a known contributor to poor health. Individuals who appear to be in good health do not have a way to identify subtle changes in their health status, which might represent early evidence of disease or a degenerative condition. Moreover, individuals cannot easily collect and monitor all health information about themselves to ensure optimal health. These persistent problems in the healthcare environment are contributing to severe inefficiencies, poorer personal health, reduced quality of life, and higher costs.

### BRIEF DESCRIPTION OF THE DRAWINGS

The various embodiments are illustrated by way of example, and not by way of limitation, in the figures of the accompanying drawings in which:

FIGS. 1 and 2 illustrate an example embodiment of a health information management environment in a network-enabled ecosystem;

FIGS. 3 and 4 illustrate a mapping of features provided for a user as part of the user experience by the health information management system of an example embodiment;

FIGS. 5 through 8 illustrate sample pages of a user interface presented to a user (e.g., a patient) by the health information management system of an example embodiment when the system of the example embodiment is activated;

FIGS. 9 through 14 illustrate sample pages of a user interface presented to an authorized user (e.g., a clinician, a healthcare provider, information technology [IT] staff) by the health information management system of an example embodiment when the system of the example embodiment is activated;

FIG. 15 is a processing flow chart illustrating an example embodiment of a method as described herein;

FIG. 16 illustrates another example embodiment of a networked system in which various embodiments may operate; and

FIG. 17 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details. In all cases, use of the term “or” is nonexclusive and may include one or more listed options, or combinations of listed options.

In the various embodiments described herein, a system and method for aggregation and intelligent analysis of individual health data with multimodal communication are disclosed. The various embodiments enable collection of individual health data from multiple sources and aggregation of a person's complete health history and status. The various embodiments enable individuals to easily and timely collect and monitor all health-related information about themselves to ensure optimal health. The various embodiments provide tools to promote and encourage improved self-management and adherence to recommended health activities (including, but not limited to, diet, physical and mental activity, medication, appointments, prostheses, self-examination, and monitoring). Such tools can include, but are not limited to, socialization, social networks, simplifying communication with family and friends, teleconferencing, messaging, reminders, notifications, feedback, games, rewards, and similar tools.

The various embodiments described herein provide a health information management environment that includes a combination of hardware, software, and processes. The hardware provides a software platform and multi-modal communication interfaces to support the software and human processes. A particular embodiment includes a computer, or other computing platform, which supports multiple video interfaces (e.g., High-Definition Multimedia Interface [HDMI], monitor) and multiple data interfaces (e.g., Universal Serial Bus [USB], Secure Digital [SD] card interfaces, cell phone interfaces, internet interfaces) with multiple communication options (e.g., voice, text, email, Bluetooth, Bluetooth Low Energy, WiFi, NFC, RFID). Bluetooth is a wireless technology standard for exchanging data over short distances using short wavelength, ultra-high frequency (UHF) radio waves. WiFi is a local area wireless technology that allows an electronic device to exchange data or connect to the internet using UHF or super high frequency (SHF) radio waves. Near-field communication (NFC) is a form of short-range wireless communication where the antenna used is much smaller than the wavelength of the carrier signal. Radio frequency identification (RFID) is a well-known technology for the wireless non-contact use of radio-frequency electromagnetic fields to transfer data, for the purposes of automatically identifying and tracking tags attached to objects. Bluetooth, Bluetooth Low Energy, WiFi, NFC, and RFID technologies are well-known to those of ordinary skill in the art.

The embodiments described herein constitute two separate logical components which may be physically resident in a single hardware device or distributed among two or more devices. These logical components manage the patient facing functions (herein called the medical hub) and the provider facing functions (herein called the data center), though in other alternate embodiments they may be referenced differently and by different names. The importance of the distinction in the two logical components is to ensure data fidelity. Further, the specific users of the medical hub and the data center will vary based on the definition of the expanded care team at different implementation sites. In one embodiment, users will not have access to the data center, and providers and other members of the expanded care team will only have access to the medical hub with the permission of the primary medical hub user. Development and support personnel will have access to the data center, but access to the medical hub will be limited to monitoring and maintaining system health, unless additional or complete access is granted by the primary medical hub user.

The software of the various embodiments described herein builds on the capabilities of the hardware to enable collection and integration of personal health information from multiple sources, including electronic health records (EHRs), wearable health and wellness devices, in-home sensors, medical devices, and the like. The hardware stores this data in a way that permits analytics software to determine adherence to a care plan (a list of steps, options, goals, medications, actions, or protocols to support optimal health, including but not limited to promoting wellness, maintaining health, and preventing, screening for, or treating disease), and institute timely action. The analytics permit identification of missing data elements and can be configured to prompt a patient or user to perform the necessary action to supply the missing data. The analytics further identify when metrics being monitored according to the care plan are out of desired limits and in response subsequently initiate communication with the person's expanded care team of healthcare providers, friends, and family.

For example, a successful and easy way to maintain a person with congestive heart failure in optimal health is to ensure that they weigh themselves every day. If a weight has not been obtained within a pre-configured grace period, the software of an example embodiment can be configured to remind the person to obtain and enter their weight. The grace period can recycle until the person enters the weight or a maximum number of reminders have been issued. In this case, the health information management system as described in various embodiments herein can initiate a notification protocol for contacting members of the person's expanded healthcare team, as described above, to encourage the person to obtain their weight. In an example embodiment, the software can store multiple hierarchical contact lists to support the notification protocol. In a particular embodiment, the system provides three sets of contact lists: social, medical, and financial, though the invention permits more lists or as few as a single list.

The software of an example embodiment includes a rules engine wherein rules definitions may be created or edited by healthcare providers or others to configure the operation of the health information management system. In particular, rules can be configured for a particular person or type of person (categorized by wellness or chronic illness) to cause the operation of the health information management system to conform to a care plan associated with the person or type of person. As part of the implementation of the person's care plan, rules can be configured to, for example, set parameters associated with a person's health status, set parameters for values missing from the care plan, set parameters associated with the trajectory of the person's health status as measured over time, and perform a variety of actions to bring a person's current health status into conformity with the pre-defined care plan. Frequencies, grace periods, contact list identifiers, and points of contact may also be set in or with the rules. The priority or severity of a notification issue can also be specified. Rules can be created by an authorized user, such as a service provider, a healthcare provider, or another clinician. As a result, an example embodiment can provide data aggregation with patient healthcare process integration, inferential analytics using defined rule sets, and service integration including alert notification with medical and social support. A sample embodiment can also provide support for care plan adherence through rewards, games, socialization, social networks, simplifying communication with family and friends, teleconferencing, messaging, reminders, notifications, feedback, and other techniques. Rewards include, but are not limited to financial rewards (such as cash, money, currency, gift cards, account credits, reduction in account debits, and the like), admiration of peers (often but not solely recognized with badges, peer rankings, public comments of support, participation metrics, and other forms of recognition), and positive reinforcement from respected professionals, friends, and family. Games are used to convert mundane activities into enjoyable experiences. Socialization is provided in the form of chat, video, and teleconferencing with friends, family members, and online communities of individuals with similar characteristics (especially, but not solely, persons with similar diseases). Socialization is also provided by other forms of human interaction on a regular or episodic basis. As described in more detail below, the communications function of various embodiments provide support for care plan adherence through connection via social networking sites and through multiple communication modes, including but not limited to voice, video, email, text, or chat.

The health information management system of an example embodiment implements a trusted computing environment in which individual authentication is enforced and information sharing can be controlled in a granular way to specifically configure the information that is shared with members of the person's expanded care team, including healthcare providers. The health information management system of the various embodiments puts the person in the center of the healthcare environment with control over the release and distribution of their data. The health information management system incorporates patient intake, device management, and information management as a normal part of the healthcare workflow, ensuring that the needs of hospitals, home health professionals, and other healthcare professionals can easily and effectively support patients. Given the unique design of the health information management system of the various embodiments as described herein, only a minimum of change in or to existing clinical processes is required to significantly improve the efficiency and consistency of healthcare delivery while minimizing medical errors. This is a significant value in the healthcare environment because of the need to ensure optimal patient safety and the consequent reluctance in the healthcare environment to make more than minimal changes in existing workflow.

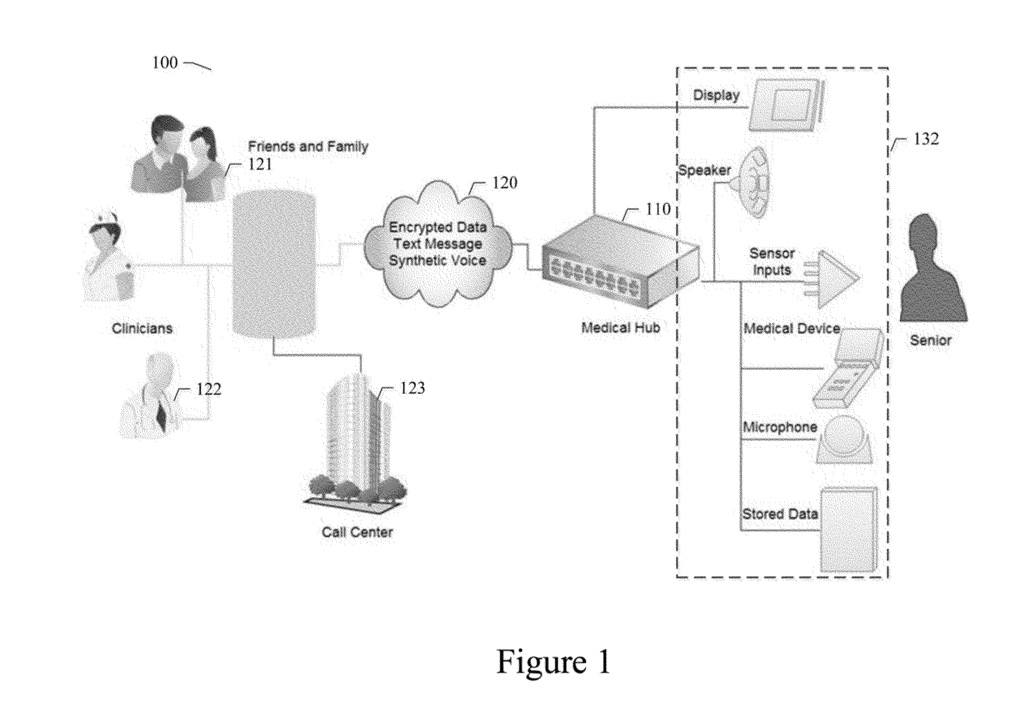

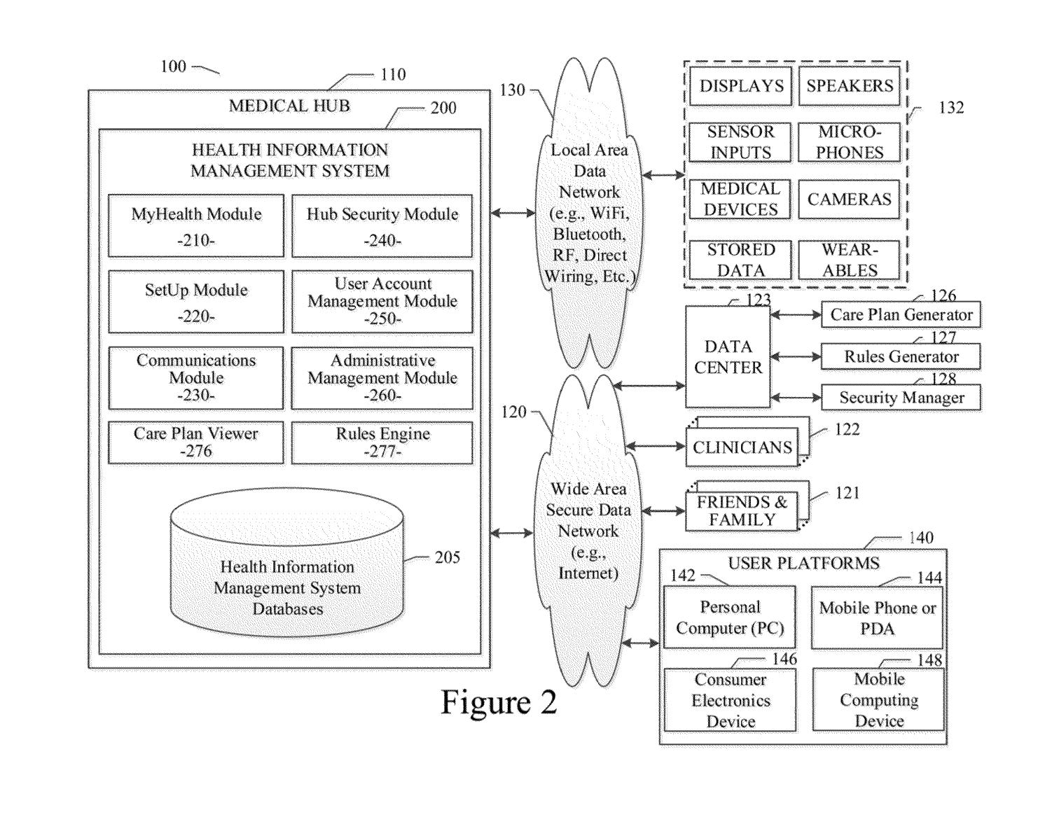

Referring now to FIGS. 1 and 2, in an example embodiment, a health information management environment 100 in a network-enabled ecosystem is disclosed. In various example embodiments, a medical hub 110 is provided at the person's location to gather personal information with medical and environmental data, perform analytical processes on the data, and perform actions for the person related to the processed health data and according to a care plan developed for the person by an authorized user, such as a clinician, healthcare provider, or home health nurse. The computer or computing system on which the medical hub 110 of an example embodiment can be implemented, in whole or in part, can include personal computers (PCs), portable computing devices, laptops, tablet computers, personal digital assistants (PDAs), wearable computing devices, personal communication devices (e.g., cellular telephones, smartphones, or other wireless devices), network computers, set-top boxes, consumer electronic devices, or any other type of computing, data processing, communication, networking, or electronic system. A software application program, running in whole or in part within an execution environment provided on the medical hub 110, gathers, processes, stores, and distributes health-related information and notifications, including personal medical information, using the computer system, web appliance, or mobile device of the health information management environment 100. The health information management system 200 shown in FIG. 2 represents an example embodiment of the software application program executed on the medical hub 110. In an alternative embodiment described in more detail below, the health information management system 200 can be executed in whole or in part within an execution environment provided on one or more network-connectible host servers or mobile devices.

In an example embodiment, the health information management system 200 operates in concert with a data center 123, as shown in FIG. 2, to coordinate the generation and implementation of personal care plans, to manage the creation and use of computer-implemented rules that define actions to be taken according to the care plans, and to manage system security and data integrity. As described in more detail below, the data center 123 can be in network data communication with the medical hub 110 and with the health information management system 200 operating therein for a particular embodiment. The details of the health information management system 200 and the data center 123 are described below.

Medical hub functionality—The medical hub 110 includes functionality that permits identification and authentication of users permitted access to the medical hub 110, and selection and display of only those pages or features to which the authenticated user has been granted access (by the primary user or another superuser). When all access is granted, the user has the ability to review a care plan and each of its components, to review progress being made toward compliance with a care plan, to enter data regarding elements of a care plan, to manage a list of contacts, to manage financial accounts, to set up multiple devices, sensors, and digital connections, and to manage medical hub 110 security, including user access, provider access, password management, and permanently deleting all data. The medical hub 110 can manage data encryption, audit trails, its own system health, system updates, context sensitive help, and the implementation of previously-generated care plan rules, including when to communicate notifications and alerts without intervention by the user.

Data center functionality—The data center 123 enables remote access to the medical hub 110 by authorized users (e.g., patients and selected members of the expanded care team) after successful authentication. The data center 123 enables an authorized user to monitor the operational status and proper functioning of the medical hub 110, to send software updates to the medical hub 110, to store encrypted backups of the data from the medical hub 110, to manage allocation and registration of each medical hub 110, to manage the help system repository (a content management system of information transmitted to each medical hub for local context sensitive help), to manage the languages available for distribution with the medical hub 110, to provide the ability of authenticated providers to identify all of their patients and to view, add, or modify care plans or care plan rules for each patient, and to review the medical hub 110 data for each patient.

In various alternative embodiments, an application or service, typically implemented by or operating on the data center 123 or a host server or site (e.g., a website), can be provided to simplify and facilitate the downloading or hosted use of the health information management system 200 of an example embodiment. In a particular embodiment, the health information management system 200, or a portion thereof, can be downloaded to the medical hub 110 from the data center 123 or a host site via a wide area secure data network (e.g., the Internet) 120 by a user at the medical hub 110, a user at the data center 123, or a user at a user platform 140. In this configuration, the health information management system 200, or a portion thereof, can be executed locally at the person's location. Alternatively, the health information management system 200 can be hosted by a host site for a networked user at the medical hub 110 or user platform 140. The details of the health information management system 200 and the data center 123 of an example embodiment are provided below.

Referring again to FIG. 2, the data center 123, the health information management system 200, and the medical hub 110 can be in network communication with remotely located users or sites via a wide area data network 120. As described in more detail below, various components at the patient's location can also communicate locally via a local area network (LAN) 130. Networks 120 and 130 are configured to couple one electronic device with another electronic device. Networks 120 and 130 may be enabled to employ any form of computer readable media for communicating information from one electronic device to another. Network 120 can include the Internet, secure wide area networks (WANs), packet-switched networks, circuit-switched networks, cellular telephone networks, or any other conventional data network servicing local and remote clients. Network 130 can include local wireless data network technologies, such as Bluetooth, Bluetooth Low Energy, WiFi, NFC, RFID, directly wired connections, such as through an Ethernet port, FireWire, a USB port, SD card interfaces, or other forms of computer-readable media, or any combination thereof. On an interconnected set of networks, including those based on differing architectures and protocols, a router or gateway device can act as a link between networks, enabling messages to be sent between networked devices. Also, communication links within networks may include optical fiber data lines, twisted wire pairs or coaxial cable, while communication links in wide area networks may utilize telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 130 may further include any of a variety of wireless sub-networks that may further overlay stand-alone ad-hoc networks, and the like, to provide an infrastructure-oriented connection. Such sub-networks may include mesh networks, Wireless LAN (WLAN), cellular networks, and the like. Networks 120 and 130 may also include an autonomous system of terminals, gateways, routers, and the like connected by wireless radio links or wireless transceivers. These connectors may be configured to be moved freely and randomly and to organize themselves arbitrarily, such that the topology of networks 120 and 130 may change rapidly and arbitrarily.

Networks 120 and 130 may further employ any of a plurality of access technologies including 2nd (2G), 2.5, 3rd (3G), or 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices of user platforms 140, with various degrees of mobility. For example, networks 120 and 130 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 130 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 130 may include virtually any wired or wireless communication mechanisms by which information may travel between one electronic device and another electronic device, network, and the like.

The health information management system 200, medical hub 110, and the data center 123 can be implemented using any form of network transportable digital data. The network transportable digital data can be transported in any of a group of data packet or file formats, protocols, and associated mechanisms usable to enable a medical hub 110, user platform 140, host site, or data center 123 to transfer data over a network 120. In one embodiment, the data format for a user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JavaScript Object Notation) format can be used to stream the interface content to the medical hub 110 or various user platform 140 client devices. JSON is a text-based open standard designed for human-readable data interchange. The JSON format is often used for serializing and transmitting structured data over a network connection. JSON can be used in an embodiment to transmit data from or to a server, device, or application, wherein JSON serves as an alternative to XML. Other embodiments can use JavaScript, Cascading Style Sheets (CSS), PHP, or other languages. These computer programming languages or protocols are well-known to those of ordinary skill in the art. The HyperText Transfer Protocol (HTTP) or secure HTTP (HTTPS) can be used as a network data communication protocol.

In a particular embodiment, a user platform 140 with one or more client devices enables a user to access data and provide data or instructions for the health information management system 200 via the medical hub 110, the data center 123, or the network 120. Particular instances of user platforms 140 include those for friends and family 121 of the person, clinicians 122 serving the person, and the call center or data center 123 supporting the person. Each of these user platform instances can enable an authorized user to access the medical hub 110 or the data center 123 using any of the client devices of the user platform 140. The client devices of the user platform 140 may include virtually any type of electronic device that is configured to send and receive information over a network, such as network 120. Such client devices may include portable devices 144, such as cellular telephones, smartphones, display pagers, radio frequency (RF) devices, infrared (IR) devices, global positioning devices (GPS), PDAs, handheld computers, wearable computers, tablet computers, integrated devices combining one or more of the preceding devices, and the like. The client devices may also include other computing devices, such as PCs 142, multiprocessor systems, microprocessor-based systems, distributed computers, network PCs, and the like. The client devices may also include other processing devices, such as programmable consumer electronics (CE) devices 146 or other mobile computing devices 148, which are known to those of ordinary skill in the art. As such, the client devices may range widely in terms of capabilities and features. Moreover, a web-enabled client device may include a browser application enabled to receive and to send wireless application protocol (WAP) messages, or wired application messages, and the like. In general, a web-enabled device is one configured for use through, or in conjunction with, the World Wide Web or Internet. A web-enabled device may be accessed through a web browser or configured to connect to other web-based applications. In one embodiment, the browser application is enabled to employ HTML, Dynamic HTML, Handheld Device Markup Language (HDML), Wireless Markup Language (WML), WMLScript, CSS, JavaScript, Extensible HTML (xHTML), Compact HTML (CHTML), and the like, to display or send digital information. In other embodiments, mobile devices can be configured with applications (apps) with which the functionality described herein can be implemented.

The client devices may also include at least one client application that is configured to send and receive content data or control data from another computing device via a wired or wireless network transmission. The client application may include a capability to provide and receive textual data, graphical data, video data, audio data, and the like. Moreover, the client devices may be further configured to communicate or receive a message, such as through email, Short Message Service (SMS), direct messaging (e.g., Twitter), Multimedia Message Service (MMS), instant messaging (IM), internet relay chat (IRC), Internet Relay Chat (mIRC), Jabber, Enhanced Messaging Service (EMS), text messaging, Smart Messaging, Over the Air (OTA) messaging, or the like, to or from another computing device, and the like.

As one option, the health information management system 200, or a portion thereof, can be downloaded to a client device of a user platform 140 and executed locally on the client device. The downloading of the health information management system 200 application, or a portion thereof, can be accomplished using conventional software downloading functionality. As a second option, the health information management system 200, or a portion thereof, can be hosted offsite and executed remotely, from the user's perspective, on the host system. In one embodiment, the health information management system 200 can be implemented as a service in a service-oriented architecture (SOA), in a Software-as-a-Service (SAAS) architecture, or similar design which permits execution remote to the user, including but not limited to cloud services. In any case, the functionality performed by the health information management system 200 is as described herein, whether the application is executed locally or remotely, relative to the user.

Referring again to FIG. 2, the medical hub 110 and health information management system 200 of an example embodiment are shown to include a health information management system database 205. The database 205 is used in an example embodiment for data storage of information related to personal records, EHRs, health data, care plan data, rules, configuration data, scheduling data, contact information, reporting data, local and remote sensor data, wearable device data, and the like. It will be apparent to those of ordinary skill in the art that the database 205 can represent multiple datasets and can be used for the storage of a variety of data in support of the health information management system 200 of an example embodiment. Further, the database 205 can be stored locally, in whole or in part, at the medical hub 110 or the data center 123, or stored remotely, in whole or in part, at a network-connectible host site. Wherever physically stored, the database 205 is encrypted and the integrity and confidentiality of the data is further protected by granular security, audit, and access measures. As described in more detail below, a variety of security functions are provided to manage the security of the database 205.

Referring again to FIG. 2, the medical hub 110 of an example embodiment is shown to include the health information management system 200. The health information management system 200 can include a myhealth module 210, a setup module 220, a communications module 230, a hub security module 240, a user account management module 250, an administrative management module 260, a care plan viewer module 276, and a rules engine 277. Each of these modules can be implemented as software components executing within an executable environment of the health information management system 200 operating wholly or in part on the medical hub 110 or the user platform 140. Each of these modules of an example embodiment is described in more detail below in connection with the figures provided herein.

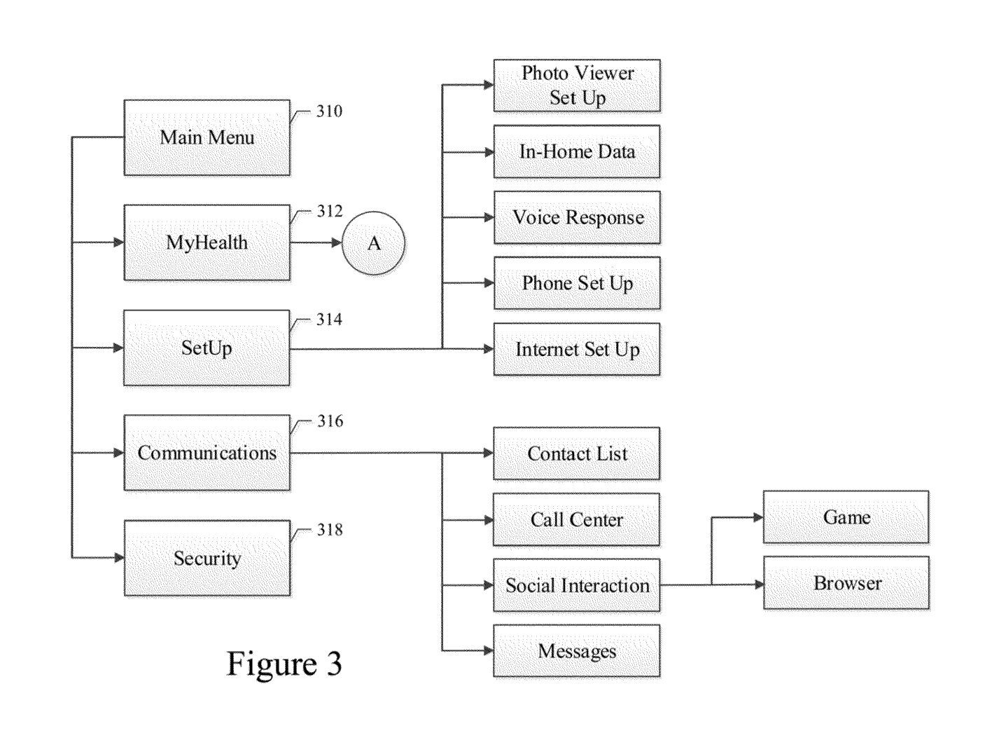

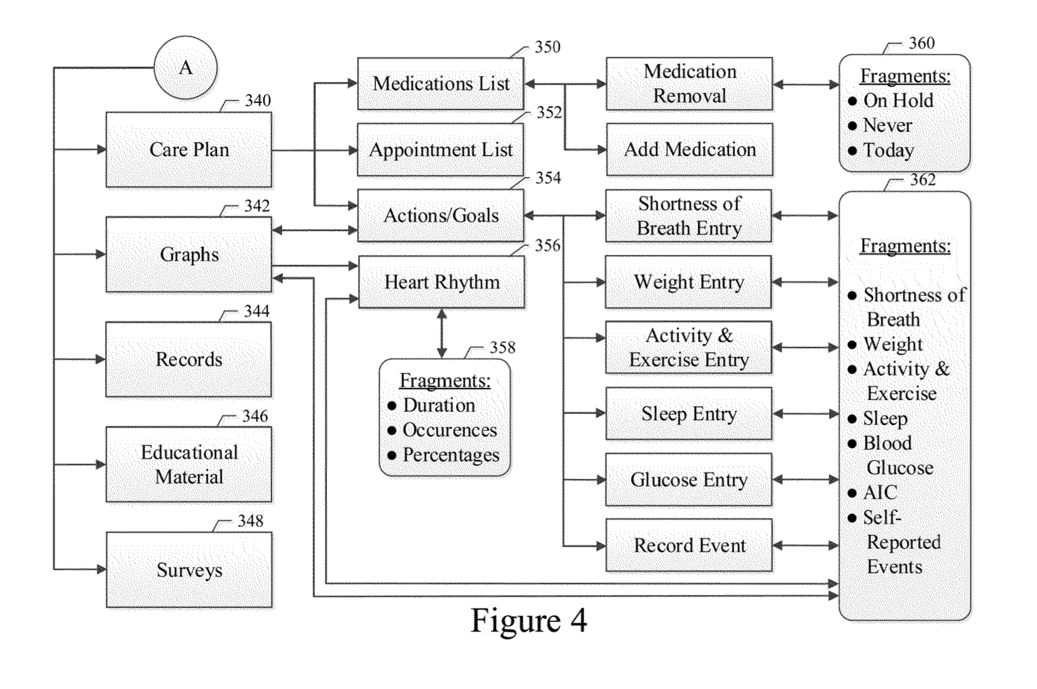

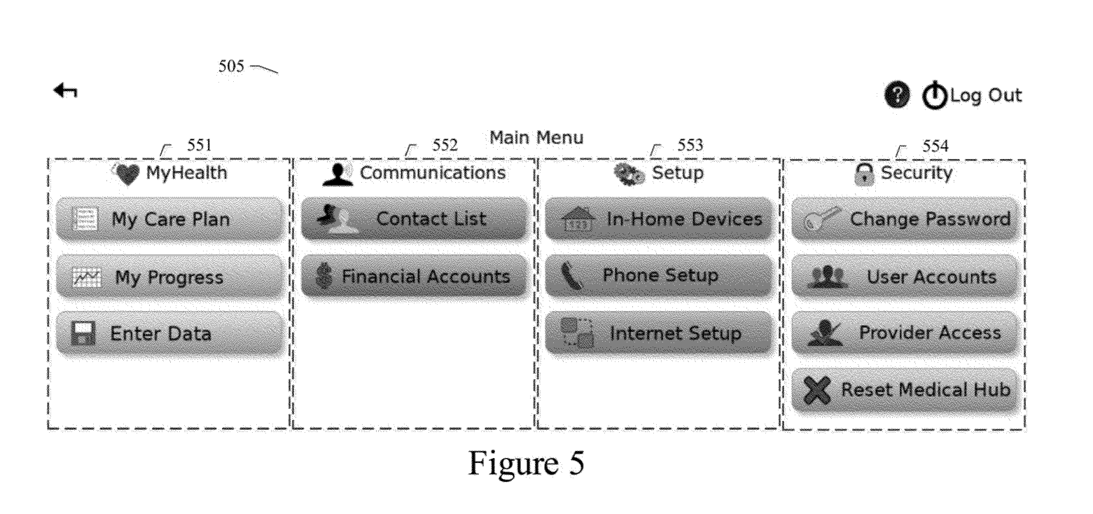

FIGS. 3 and 4 illustrate a mapping of features, functions, and functionality of an example embodiment provided for a user as part of the user experience by the health information management system 200. As shown in FIG. 3, a main menu function 310 is executed on the initial activation of the health information management system 200 after a user has been authenticated using one or more pre-defined secure login protocols. A corresponding main menu 505, as shown in FIG. 5 and described below, is presented to the user when the main menu function 310 is executed. As shown in FIG. 3, the main menu function 310 provides access for the user to at least four other functions in an example embodiment. These functions include: a myhealth function 312, a setup function 314, a communications function 316, and a security function 318. In the example embodiment, these functions correspond to or are implemented by the myhealth module 210, the setup module 220, the communications module 230, and the hub security module 240, respectively. In the example embodiment, the implementation of these functions can be assisted by the care plan generator 126, the rules generator 127, and the security manager 128 operating at the data center 123. The operation of each of these functions is described in more detail below and in connection with FIGS. 5 through 8.

Referring again to FIG. 3, the myhealth function 312 provides access for the authorized user to at least five other functions in an example embodiment as shown in FIG. 4 under the bubble A. The operation of each of these functional components of the myhealth function 312 is described in more detail below and in connection with FIGS. 4 through 8.

Referring again to FIG. 3, the setup function 314 provides access for the authorized user to configure a variety of other functions in an example embodiment as shown in FIG. 3. The setup function 314 enables the authorized user to configure the medical hub 110, devices connectible thereto, and datasets associated with particular persons or other users. For example, the setup function 314 enables a user to configure a telephone interface, an internet connection interface, a photo viewer device interface, displays, speakers, microphones, cameras, or any of a variety of other device interfaces. Additionally, a variety of in-home or at-location devices, whether medical grade (e.g. approved by the FDA) or consumer grade, such as sensors, data collectors, medical devices, wearable devices, or other connectible devices can be configured and enabled using the setup function 314. One or more datasets associated with a particular person or user can also be password-protected using the setup function 314.

Referring still to FIG. 3, the communications function 316 provides access for the user to a variety of communication-related functions in an example embodiment as shown in FIG. 3. The communications function 316 enables a user to configure the medical hub 110 for communication with a variety of network-accessible parties, such as friends, family, colleagues, or clinicians, for whom contact information is maintained in a contact list. The communications function 316 is described in more detail below in connection with FIG. 5.

Referring still to FIG. 3, the security function 318 provides access for an authorized user to a variety of system security-related functions in an example embodiment. The security function 318 enables an authorized user to configure the security features of the medical hub 110, such as password management, the access privileges of users, the privacy levels of personal and user datasets, and the like. Additionally, the security function 318 in an example embodiment enables an authorized user to configure user accounts, enable health provider and clinician access, create or change passwords, and reset the medical hub 110 to its initial blank state.

Referring now to FIG. 4, the myhealth function 312, shown in FIG. 3, provides access for the authorized user to at least five other functions in an example embodiment as shown in FIG. 4 under the bubble A. The myhealth function 312 enables a user to access and follow a care plan for a person, check the status and progress of a person, capture and view a variety of health data, and provide educational materials for the person. The myhealth function 312 in an example embodiment includes: a care plan function 340, a graphs function 342, a records function 344, an educational materials function 346, and a surveys function 348. The records function 344 enables a user to access, read, or review a person's medical records on the medical hub 110. The educational materials function 346 provides access for the user to a variety of medical reference materials, videos, audio recordings, documents, articles, internet sources, and other materials for educating the user or person on various health or medical topics. The surveys function 348 enables a user to view or complete a survey related to a particular health or medical issue.

Referring still to FIG. 4, the care plan function 340 of an example embodiment provides access for the user to a variety of care plan-related functions in an example embodiment as shown in FIG. 4. In an example embodiment, the care plan function 340 is supported by the care plan viewer 276 and the rules engine 277 operating on the medical hub 110 and the care plan generator 126 and the rules generator 127 operating at the data center 123. Collectively, these care plan functions enable an authorized user (e.g., a clinician, healthcare provider, home health nurse) at or through the data center 123 to configure the person's care plan with respect to at least three aspects: a medication list 350, an appointment list 352, and a set of actions and goals 354 associated with the care plan. The medication list 350 of a particular person can be created and modified to add or remove medications from the person's list. A set of fragments 360 representing messages, prompts, or qualifiers can be presented to the user as part of the medication list configuration. Similarly, the appointment list 352 of a particular person can be created and modified to add or remove appointments from the list or calendar for a particular person. Once the care plan is created and configured for the person by use of the care plan generator 126 at or through the data center 123, an authorized user at the medical hub 110 (e.g., a patient or a representative of the patient) can use the care plan viewer 276 to access the care plan, add data as prompted by the care plan, and follow the implementation of the care plan as defined by the person's care providers. The care plan can include a set of user defined and computer-generated rules that can be created and modified by an authorized user by use of the rules generator 127 at or through the data center 123. The rules can specify automated actions that can be performed for the person as part of the care plan. The rules engine 277 at the medical hub 110 can execute these rules as part of the care plan.

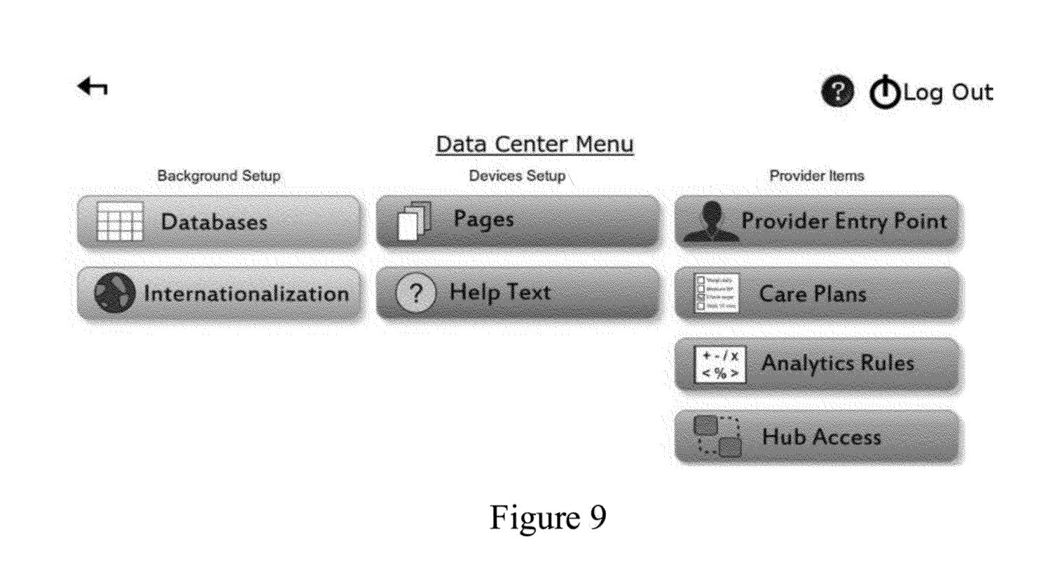

Referring still to FIG. 4 and as described above, the care plan function 340 and the care plan viewer 276 of an example embodiment enable a user to access the care plan, add data as prompted by the care plan, and follow the implementation of the care plan as defined by the person's care providers. The care plan can include a related set of actions and goals 354. The set of actions and goals 354 comprise a collection of health-related metrics and corresponding actions associated with a particular person. These metrics can include all information or parameters related to the person's health, including but not limited to breathing patterns, the person's weight, activity or exercise level, characteristics of sleep, blood glucose or other laboratory or imaging results, and other notable events in the person's health. The metrics can also include daily living metrics, such as whether motion of an individual is detected, whether door movement is detected, whether dangerous conditions at the location are detected, whether sleep is detected, whether tagged device activation is detected, whether use of television, computer, phone, or appliances is detected, whether speech or other particular sounds are detected, or a variety of other metrics, which may be monitored in the home or on a person's body. These metrics can be explicitly entered into a user interface of the medical hub 110 by a user or automatically captured periodically by the in-home or at-location sensors, medical devices, wearables, or other devices connected to the medical hub 110 through the local area network 130. As such, an example embodiment can aggregate health metrics for a particular person from a variety of sources in a variety of modes to collect the person's health data in one place. The captured metrics can be retained in the database 205 and associated or integrated with the rest of the particular person's data or related EHR data. As part of the care plan, an authorized user can also establish a schedule according to which the person's metrics should be updated by the person or by the related medical devices. A set of fragments 362 representing sample messages, prompts, or qualifiers can be presented to the user as part of the set of actions and goals 354. The configuration of the care plan is described in more detail below and in connection with FIGS. 9 through 14.

Referring still to FIG. 4, the graphs function 342 of an example embodiment enables a user to view and present a set of actions and goals 354 associated with the care plan in a graphical form. The graphs function 342 can also be used to create various views of the health data of the person in various graphs, tables, or other convenient forms. In a particular embodiment, a view or graph of the person's heart rhythm 356 can be created and configured using the graphs function 342. A sample set of fragments 358 representing messages, prompts, or qualifiers can be presented to the user as part of the configuration of the view of the heart rhythm data 356. The configuration and graphing of the care plan activity is described in more detail below and in connection with FIGS. 5 through 8.

FIGS. 5 through 8 illustrate sample pages or screenshots of a user interface presented to a user by the health information management system 200 of an example embodiment when the system of the example embodiment is operating. As described above, the health information management system 200 can be configured to operate wholly or in part on the medical hub 110 or a user platform 140. Software components executing within an executable environment of a health information management system 200 can present various pages of a user interface to a user at the medical hub 110 or a user platform 140. These pages can be presented using well-known protocols and data transfer interfaces. The main menu 505 shown in FIG. 5 is presented when an example embodiment of the health information management system 200 is initially activated or launched and the user has been successfully authenticated. As shown, the example embodiment presents a set of command or function options as softkeys, input objects, or other user interface mechanisms, which enable a user to signal activation of a desired option. As well known to those of ordinary skill in the art, such user interface input mechanisms can be implemented using touchscreens, physical buttons, regions on a display screen that can be selected using a pointing device, alphanumeric codes or keystrokes, or the like. In alternative embodiments, speech or gesture recognition, voice-to-text, text-to-voice, eye tracking, or like technologies can also be used as input mechanisms. In the example embodiment shown in FIG. 5, these command or function input options can include, among others, a myhealth input group 551, a communications input group 552, a setup input group 553, and a security input group 554. These input groups correspond to the mapped functions described above and the corresponding software modules. In particular, these input groups correspond to or are implemented by the myhealth module 210, the communications module 230, the setup module 220, and the hub security module 240, respectively.

Referring still to FIG. 5, in response to the activation of one of the options in the communications input group 552 by the user, the communications module 230 of the health information management system 200 shown in FIG. 2 takes control to process the user input and produce output related to the communications function 316 of the example embodiment. The communications function in an example embodiment enables an authorized user to configure the medical hub 110 for communication with a variety of network-accessible parties, such as friends, family, colleagues, or clinicians, for whom contact information can be maintained in a contact list. The contact list input option of the communications input group 552 enables the user to configure the contact list. The communications function also enables a user to communicate with the call center or data center 123, social networking sites, medical sites, financial sites, and the like through multiple communication modes, including but not limited to voice, video, email, text, or chat. The user can use the financial accounts input option of the communications input group 552 to configure one or more financial accounts associated with the user. It will be apparent to those of ordinary skill in the art in view of the disclosure herein that a variety of additional communications input options can be provided in alternative embodiments.

Referring still to FIG. 5, in response to the activation of one of the options in the setup input group 553 by the user, the setup module 220 of the health information management system 200 shown in FIG. 2 takes control to process the user input and produce output related to the setup function 314 of the example embodiment. As described above, the setup function 314 in an example embodiment enables a user to configure the medical hub 110, devices connectible thereto, and datasets associated with particular persons or other users. For example, the setup function 314 enables a user to configure a telephone interface, an internet connection interface, a photo viewer device interface, displays, speakers, microphones, cameras, or any of a variety of other device interfaces. The phone setup and Internet setup input options of the setup input group 553 enable the user to configure these interfaces. Additionally, a variety of in-home or at-location devices, such as sensors, data collectors, medical devices, wearable devices, or other connectible devices can be configured and enabled using the setup function 314. The in-home devices input option of the setup input group 553 enables the user to configure these devices. It will be apparent to those of ordinary skill in the art in view of the disclosure herein that a variety of additional setup input options can be provided in alternative embodiments.

Referring still to FIG. 5, in response to the activation of one of the options in the security input group 554 by the user, the hub security module 240 of the health information management system 200 shown in FIG. 2 takes control to process the user input and produce output related to the security function 318 of the example embodiment. The security function 318 enables an authorized user to configure the security features of the medical hub 110, such as the passwords used for network and local communication, the access privileges of users, the privacy levels of person and user datasets, and the like. Additionally, the security function 318 in an example embodiment enables an authorized user to configure user accounts, enable health provider and clinician access, create or change a password, and reset the medical hub 110. The change password, user accounts, provider access, and reset medical hub input options of the security input group 554 enable the user to configure these account, access, and security parameters. It will be apparent to those of ordinary skill in the art in view of the disclosure herein that a variety of additional security input options can be provided in alternative embodiments.

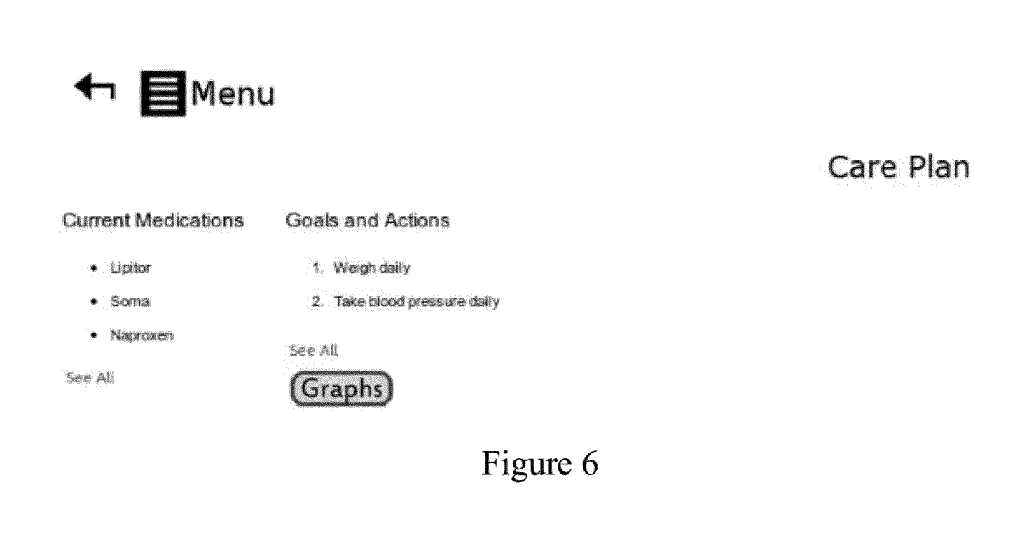

Referring still to FIG. 5, in response to the activation of one of the options in the myhealth input group 551 by the user, the myhealth module 210 of health information management system 200 shown in FIG. 2 takes control to process the user input and produce output related to the myhealth function 312 of the example embodiment. Various examples of the usage of the input options in the myhealth input group 551 of an example embodiment are described in more detail below and in connection with FIGS. 6 through 8.

FIGS. 6 through 8 illustrate sample pages of a user interface presented to a user by the health information management system 200 of an example embodiment when one of the input options in the myhealth input group 551 is activated. These myhealth input options activate corresponding functions to enable a user to view and follow a personal care plan, check the status and progress of a person, capture and view a variety of health data, and view educational materials. It will be apparent to those of ordinary skill in the art in view of the disclosure herein that a variety of additional myhealth input options can be provided in alternative embodiments. In a particular example of an embodiment described herein, the selection of the my care plan input option of myhealth input group 551 shown in FIG. 5 can cause the presentation of the sample page as shown in FIG. 6.

Referring now to FIG. 6, a sample page is shown that can be produced when the my care plan input option of the myhealth group 551 is selected. The my care plan input option activates the care plan function 340, which enables the user to review a variety of care plan-related functions in an example embodiment. This care plan function enables a user (e.g., a patient, or a patient representative) to view and follow the person's care plan with respect to at least three aspects: a medication list 350, an appointment list 352, and a set of actions and goals 354 associated with the care plan. As shown in the sample page of FIG. 6, the medication list of a particular person can be reviewed to identify the medications on the person's list and show adherence to the person's care plan. The medication list associated with the person can be used to automatically remind the person to take listed medications according to a schedule defined as part of the care plan. Additionally, the sample page shown in FIG. 6 can be used to review a set of goals and actions associated with the person's care plan. As described above, the set of actions and goals comprise a collection of health-related metrics and corresponding actions associated with a particular person. These metrics can include all information or parameters related to the person's health, including but not limited to breathing patterns, the person's weight, activity or exercise level, characteristics of sleep, blood glucose or other laboratory or imaging results, and other notable events in the person's health. The metrics can also include daily living metrics, such as whether motion of an individual is detected, whether door movement is detected, whether dangerous conditions at the location are detected, whether sleep is detected, whether tagged device activation is detected, whether use of television, computer, phone, or appliances is detected, whether speech or other particular sounds are detected, or a variety of other metrics, which may be monitored in the home or on the person's body. These metrics can be explicitly entered into a user interface of the medical hub 110 by a user or automatically captured periodically by the in-house or at-location sensors, medical devices, wearables, or other devices connected to the medical hub 110. The captured metrics and related information or meta-data can be retained in the database 205 and associated or integrated with the particular person's data or related EHR data.

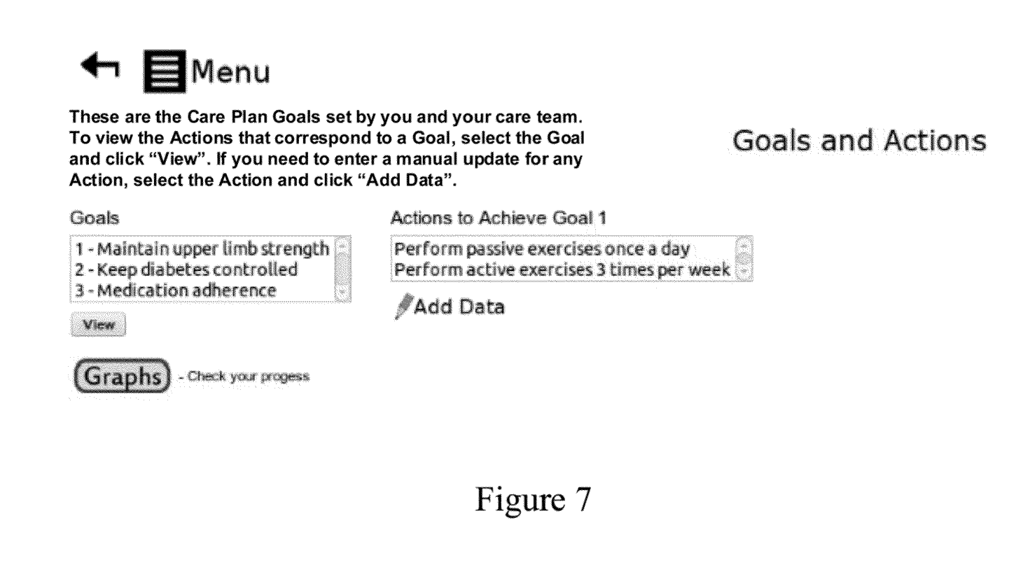

As part of the care plan pages as shown in FIGS. 6 and 7, the person can also review one or more goals and corresponding actions required or recommended to reach the specified goal, and enter data reflecting care plan actions performed. An example is shown in FIG. 7. For a particular person and as part of the person's care plan, a set of goals and related actions can be specified in the care plan by an authorized user at or through the data center 123 as described herein to transition the person along a path toward wellness by prompting and monitoring the person's progress. By defining the person's care plan as described herein, the medical hub 110 can support the person with the care plan by informing the person of the recommended goals and associated actions at the appropriate time and involving the expanded care team when additional support is needed. Additionally, the medical hub 110 can capture personal metrics (explicitly and automatically) as described above to monitor the person's progress as related to the care plan. Deviations from the care plan can be immediately detected and appropriate notifications can be automatically sent to a hierarchy of pre-defined recipients.

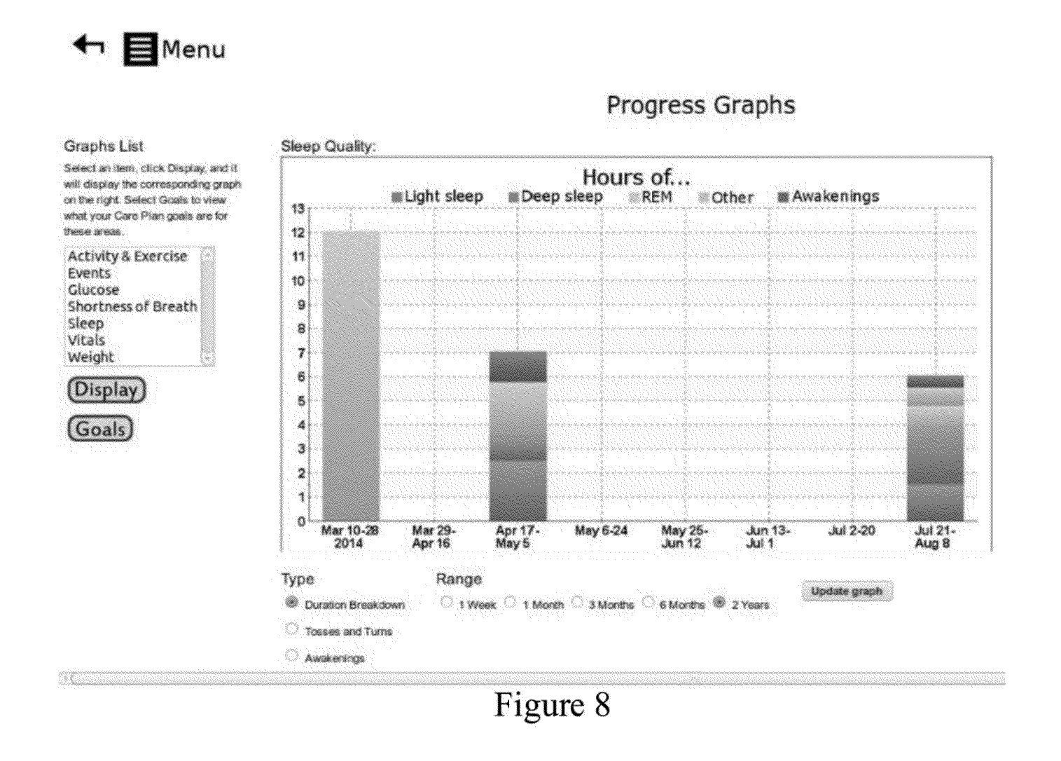

As part of the care plan page as shown in FIG. 6, the user can review a schedule according to which the person's metrics should be updated by the person or by the related medical devices. A set of goals and actions created for the person by an authorized user as part of the care plan can be viewed by the user as part of this care plan page. As part of the care plan page as shown in FIG. 6, the user can select the graphs function 342 to enable the user to view and graph information associated with the care plan. The graphs function 342 also enables a user to generate a graph of a person's health data progress. An example of a particular graph generated by the graphs function 342 of an example embodiment is shown in FIG. 8.

Referring now to FIGS. 9 through 14, a set of sample pages are shown that can be produced by a software system running at the data center 123. An authorized clinician, medical service provider, healthcare provider, home health nurse, information technology (IT) personnel, and the like are typically the users with access to the data center 123 user interface shown in the example pages of FIGS. 9 through 14, though the interface can provide access to a subset or superset of functions as shown in the figures. This data center 123 user interface, as shown in FIG. 9, enables the authorized user to manage a variety of data center-related functions in an example embodiment. In particular, the authorized data center 123 user can configure access to and status of various databases, support modifications to the databases, support addition of specific page views, support modifications to the help system, support addition of new language versions of the system, support access to specific medical hubs of specific persons, provide software and data updates or patches to one or more individual medical hubs, support modifications of rules and addition of new rules, support creation, entry, and modification of care plans, and support other data center 123 functions.

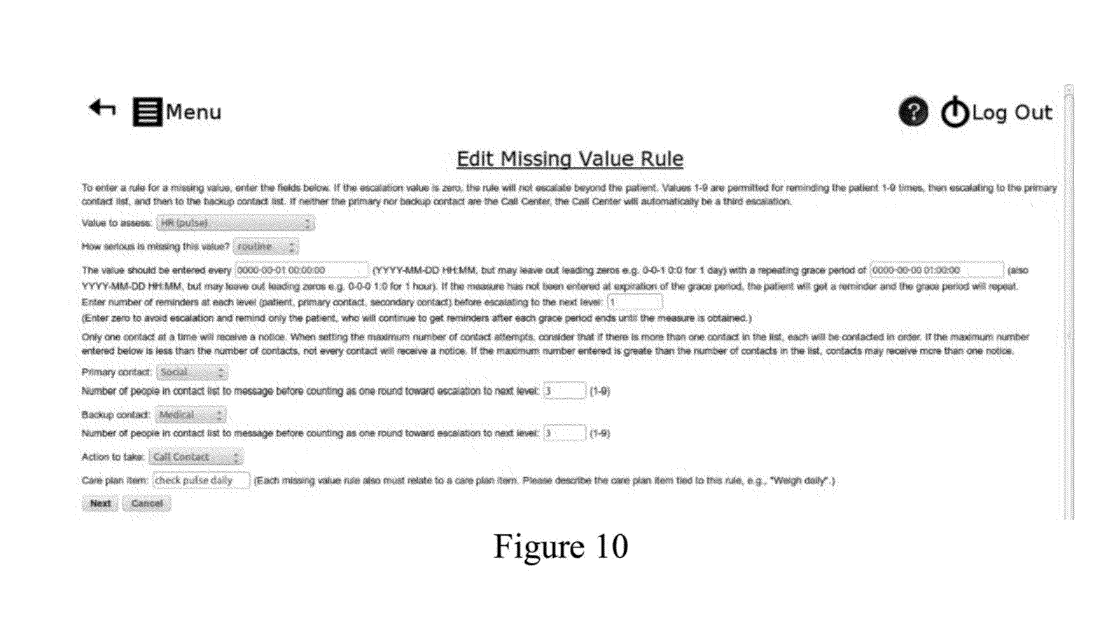

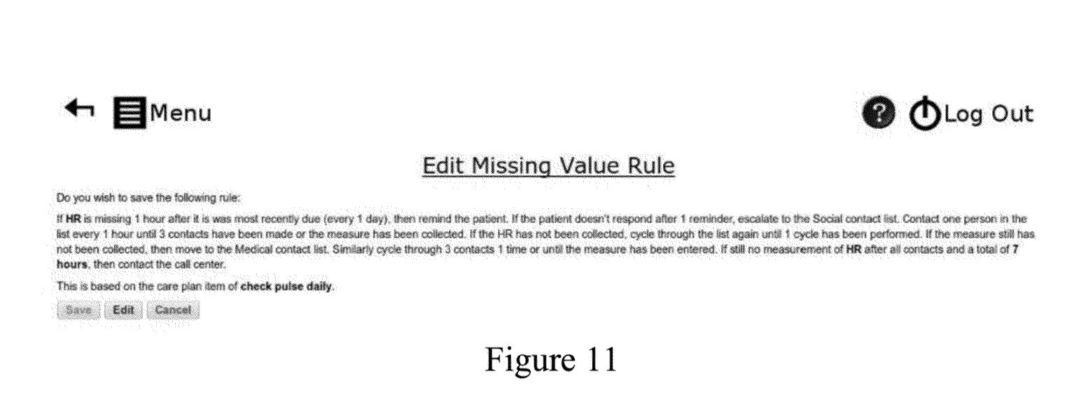

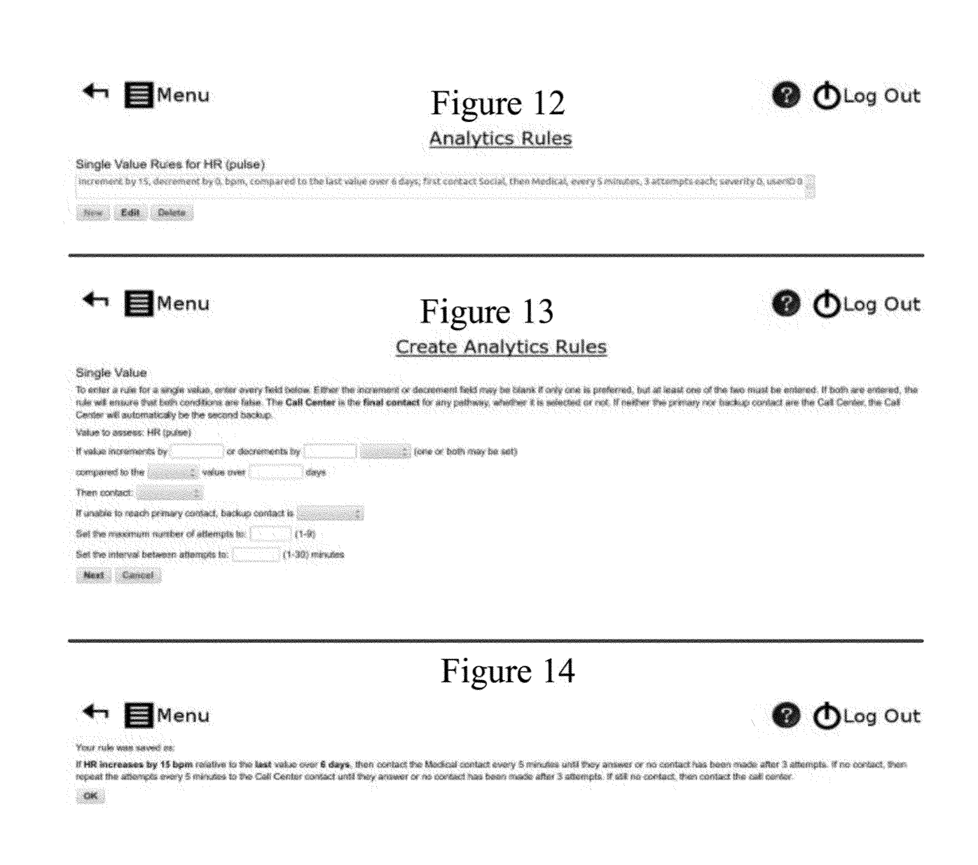

In a particular example of the rules configuration features of an embodiment as performed at or through the data center 123, FIGS. 10 and 11 illustrate a rule that can be created by an authenticated user with the rules generator 127 on the data center 123 for handling the situation when a personal metric value that was supposed to be provided as part of the person's care plan is not received within the time specified by the care plan. As described above, the authorized user can establish a schedule according to which the person's metrics should be updated by the person or by the related medical devices. As shown in the example of FIGS. 10 and 11, a set of actions and priorities can be specified in a set of rules that define the actions that should be performed if a particular personal metric is not updated according to the pre-defined schedule. For example, as shown in FIGS. 10 and 11, a particular personal metric (e.g., heart rate or pulse) can be specified by the authorized user as part of the user interface provided by the rules generator 127. A priority value related to the specified metric can also be provided. Additionally, an update schedule associated with the specified metric can be provided that defines the timing according to which the person's metrics should be updated by the person or by the related medical devices. The sample user interface shown in FIGS. 12 through 14 also enables the user to specify how to set parameters as in and out of range which create alert notifications. Based on exceeding high, dropping below low, varying from mean or median during a user defined period (e.g. 7, 30, or 90 days) by a fixed amount or a percentage, alerts or notifications can be triggered. The sample user interface shown in FIGS. 10 through 14 also enable the user to specify a hierarchical set of pre-defined recipients to which notifications can be automatically sent if the person's metrics are not timely updated by the person or by the related medical devices or if metrics fall outside of pre-defined limits. It will be apparent to those of ordinary skill in the art in view of the disclosure herein that a variety of additional rules, including but not limited to more complex rules which combine multiple simpler rules applying to one or more metrics, can be provided in alternative embodiments.

Referring again to FIG. 2 and as described above, a user platform 140 can include a mobile device on which a mobile application (app) can be executed. An example embodiment, implemented as a mobile device app, can be used to support a mobile device user interface for the health information management system 200 of an example embodiment. It will be apparent to those of ordinary skill in the art that other embodiments can also be implemented as a web app with one or more webpages or other types of user interfaces. A mobile version of an example embodiment provides a user-friendly interface from which the user can easily view or update the relevant personal information from a mobile device. As described in more detail herein, a mobile software app embodying a mobile version of an example embodiment as described herein can be installed and executed on a mobile device, such as a smartphone, laptop computer, tablet device, or the like. In an example embodiment, a splash screen appears whenever the user opens or launches the mobile application on the mobile device. This splash screen can display a host logo and wallpaper image while opening the login screen prior to accessing a live feed of processed personal information.

User log-in functionality on the medical hub 110, user platform 140, or in the mobile app provides a user-friendly user interface in which the user can provide a user identifier (ID) and password associated with the user account, which may be performed by direct user entry of the ID and password or through an alternate means, such as voice, fingerprint or swipe, which performs a similar function. If the user does not have an account, the user will be unable to access the data in the health information management system 200. To ensure high security is maintained, user accounts may only be created physically on the medical hub 110 either at initialization of the system or by a previously authenticated superuser. The process of creating a user account in an example embodiment is simple and only requires the user to provide a set of user-specific data to the primary user or another superuser. After entering this information, the superuser can create an account for the new user and provide access to the health information management system 200. Depending upon the permission level provided for the user, the user may have full access to the data and features corresponding to the permission level, including videoconferencing or data entry.

Referring again to FIG. 2, the health information management system 200 of an example embodiment is also shown to include a user account management module 250. The user account management module 250 can be used to maintain user accounts on the medical hub 110. The user account management module 250 can also be used to configure user settings, maintain a profile on medical hub 110, and otherwise manage user data and user parameters on the medical hub 110. In the example embodiment described herein, an authorized user can be registered as an identified user in order to share information, health records, communications, or other content. The registered user can modify their user ID and password on first login, but may only modify their password thereafter. Once this information is entered, a user account is validated and the user can share information, health records, communications, or other content. In an example embodiment, only a recognized superuser in the physical presence of the medical hub 110 is authorized to add a new user to the system.

Referring again to FIG. 2, the health information management system 200 of an example embodiment is shown to include an administrative management module 260. The administrative management module 260 can be used by an authorized user or superuser of the health information management system 200 to manage user accounts and to manage the health information management system 200. The administrative management module 260 can also be used to enforce privacy protections and content controls for users. Moreover, the administrative management module 260 can also be used to generate or process a variety of analytics associated with the operation of the health information management system 200. For example, the administrative management module 260 can generate various statistical models that represent the activity of the community of users and related persons to support population health management for clinicians, care team members, affiliates, and the like. In this example embodiment, these analytics can be shared, licensed, or sold to others in accordance with applicable privacy protections with the permission of the primary medical hub user.

In addition, an example embodiment can collate information about the medications being used by the person with their signs, symptoms, and findings, which may indicate an adverse reaction to one or more medications and cause one or more of several actions to promote personal safety, including but not limited to: notifying the person or their clinical provider, putting the care plan item representing the medication on hold, or reporting for post-market drug surveillance.

Although the various user interface displays provided by the example embodiments described herein are nearly infinitely varied, several sample user interface displays and sequences are provided herein and in the corresponding figures to describe various features of the disclosed embodiments. These sample user interface displays and sequences are described herein and in the accompanying figures. It will be apparent to those of ordinary skill in the art that equivalent user interface displays and sequences can be implemented within the scope of the inventive subject matter disclosed and claimed herein.

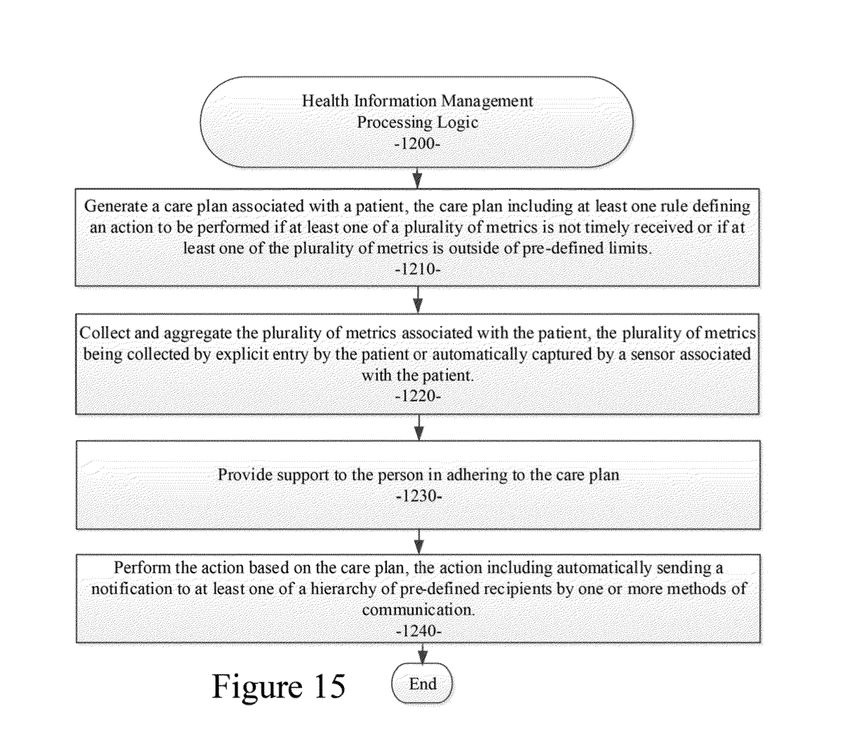

Referring now to FIG. 15, a processing flow diagram illustrates an example embodiment of a health information management system 200 as described herein. The method 1200 of an example embodiment includes: generating a care plan associated with a person, the care plan including at least one rule defining an action to be performed if at least one of a plurality of metrics is not timely received or if at least one of the plurality of metrics is outside of pre-defined limits (processing block 1210); collecting and aggregating the plurality of metrics associated with the person, the plurality of metrics being collected by explicit entry by the person or automatically captured by a sensor associated with the person (processing block 1220); providing support to the person in adhering to the care plan (processing block 1230); and performing the action based on the care plan, the action including automatically sending a notification to at least one of a hierarchy of pre-defined recipients by one or more methods of communication (processing block 1240).

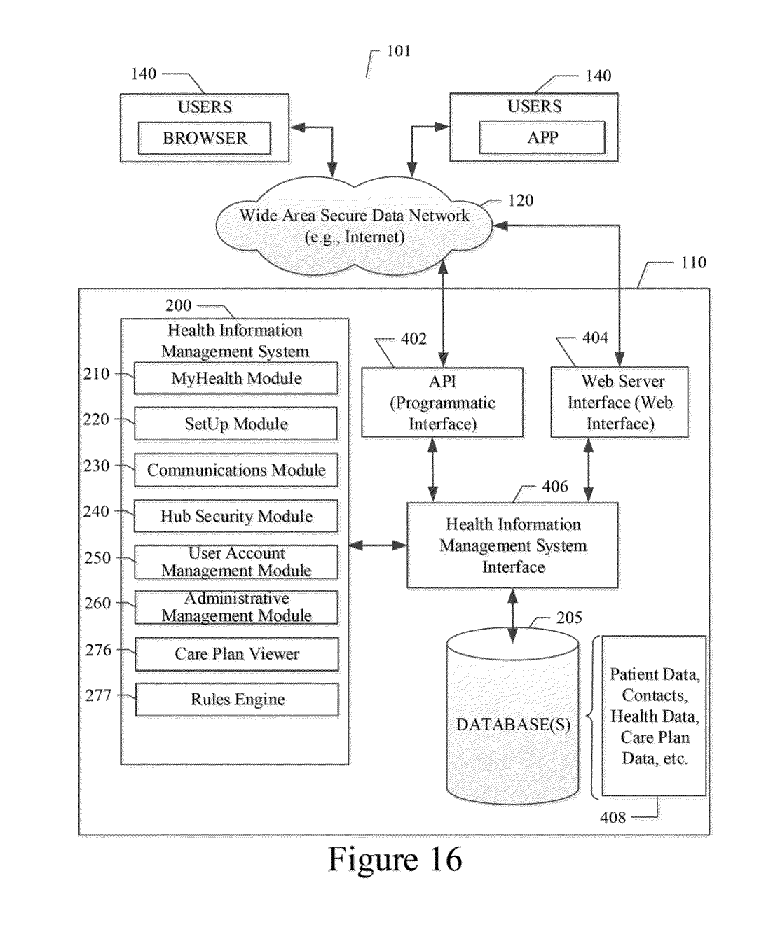

Referring now to FIG. 16, another example embodiment 101 of a networked system in which various embodiments may operate is illustrated. In the embodiment illustrated, the medical hub 110 is shown to include the health information management system 200. The health information management system 200 is shown to include the functional components 210 through 260, as described above. In a particular embodiment, the medical hub 110 may also include a web server interface 404, implementing a web interface with which users may interact with the medical hub 110 via a World Wide Web user interface or web interface. The medical hub 110 may also include an application programming interface (API) 402 with which the medical hub 110 may interact with other network entities on a programmatic or automated data transfer level. The API 402 and web interface 404 may be configured to interact with the health information management system 200 either directly or via an interface 406. The health information management system 200 may be configured to access a data storage device 205 and data 408 therein either directly or via the interface 406.

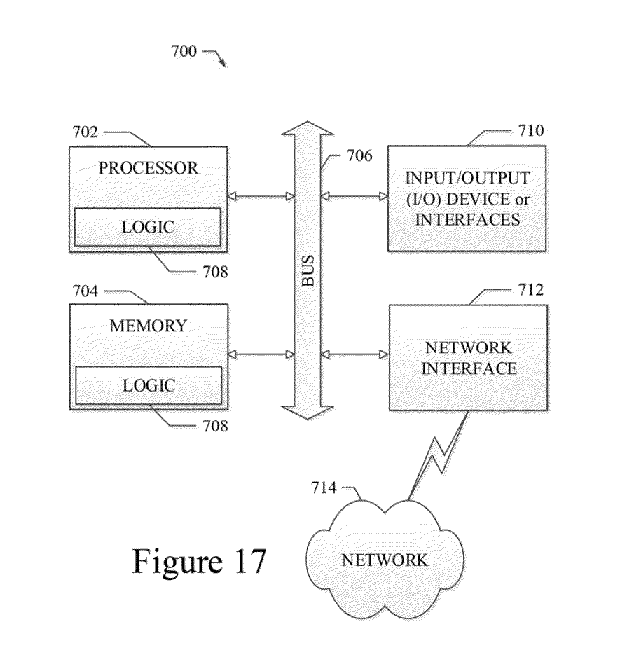

FIG. 17 shows a diagrammatic representation of a machine in the example form of a stationary or mobile computing or communication system 700 within which a set of instructions when executed or processing logic when activated may cause the machine to perform any one or more of the methodologies described or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a PC, a laptop computer, a tablet computing system, a PDA, a cellular telephone, a smartphone, a server, a web server, a standalone Linux server, a web appliance, a set-top box (STB), a network router, a switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described or claimed herein.

The example stationary or mobile computing or communication system 700 includes a data processor 702 (e.g., System-on-a-Chip [SoC], general processing core, graphics core, and optionally other processing logic) and a memory 704, which can communicate with each other via a bus or other data transfer system 706. The stationary or mobile computing or communication system 700 may further include various input/output (I/O) devices or interfaces 710, such as a monitor, touchscreen display, keyboard or keypad, cursor control device, still or video camera, microphone, voice interface, and optionally an USB, SD, or network interface 712. In an example embodiment, the network interface 712 can include one or more network interface devices or radio transceivers configured for compatibility with any one or more standard wired or wireless network data communication protocols, wireless or cellular protocols, or access technologies described above. In essence, the network interface 712 may include or support virtually any wired or wireless communication mechanisms by which information may travel between the stationary, mobile computing, or communication system 700 and another computing or communication system via a network 714.

The memory 704 can represent a machine-readable medium on which is stored one or more sets of instructions, software, firmware, or other processing logic (e.g., logic 708) embodying any one or more of the methodologies or functions described or claimed herein. The logic 708, or a portion thereof, may also reside, completely or at least partially within the processor 702 during execution thereof by the stationary or mobile computing or communication system 700. As such, the memory 704 and the processor 702 may also constitute machine-readable media. The logic 708, or a portion thereof, may also be configured as processing logic or electronic logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, or associated caches and computing systems) that store the one or more sets of instructions. The term “machine-readable medium” can also be taken to include any non-transitory medium that is capable of storing, encoding, or carrying a set of instructions for execution by the machine and that cause the machine to perform any one or more of the methodologies of the various embodiments, or that is capable of storing, encoding, or carrying data structures utilized by or associated with such a set of instructions. The term “machine-readable medium” can accordingly be taken to include, but is not limited to, solid-state memories, optical media, and magnetic media, which in some embodiments may also be I/O devices.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in any subset of all features of a single disclosed embodiment. Thus, the following claims are hereby incorporated into the Detailed Description, with each claim standing on its own as a separate embodiment.

What is claimed is:

1. A computer-implemented method comprising:
generating a care plan associated with a person, the care plan including at least one rule defining an action to be performed if at least one of a plurality of metrics is not timely received or if at least one of the plurality of metrics is outside of pre-defined limits;
collecting and aggregating the plurality of metrics associated with the person, the plurality of metrics being collected by explicit entry by a user or automatically captured by a sensor associated with the person;
providing support to the person in adhering to the care plan; and
performing the action based on the care plan, the action including automatically sending a notification to at least one of a hierarchy of pre-defined recipients by one or more methods of communication.

2. The method of claim 1 wherein the plurality of metrics associated with the person is collected from a plurality of different sources.

3. The method of claim 1 wherein the plurality of metrics associated with the person is collected from a plurality of devices associated with the person.

4. The method of claim 3 wherein the plurality of devices includes wired or wireless devices compatible with at least one networking technology from the group consisting of: Bluetooth, WiFi, near-field communication (NFC), radio frequency identification (RFID), Ethernet, FireWire, universal serial bus (USB), and Secure Digital (SD) card.

5. The method of claim 1 including integrating metrics from the person's electronic health record (EHR).

6. The method of claim 1 including specifying a priority or severity corresponding to the notification.

7. The method of claim 1 wherein the plurality of metrics associated with a person is stored in a database at a location proximate to the person.

8. The method of claim 1 including communicating periodically with a data center via a network data transmission.

9. The method of claim 1 wherein generating the care plan includes generating a medication list, an appointment list, and a set of actions and goals specific to the person's clinical conditions or wellness goals.

10. A system comprising:
a data processor;
a network interface, in data communication with the data processor, for communication on a data network; and
a health information management system, executable by the data processor, to:
receive a care plan associated with a person, the care plan including at least one rule defining an action to be performed if at least one of a plurality of metrics is not timely received or if at least one of the plurality of metrics is outside of pre-defined limits;
collect and aggregate the plurality of metrics associated with the person, the plurality of metrics being collected by explicit entry by a user or automatically captured by a sensor associated with the person;
provide support to the person in adhering to the care plan; and
perform the action based on the care plan, the action including automatically sending a notification to at least one of a hierarchy of pre-defined recipients by one or more methods of communication.

11. The system of claim 10 wherein the plurality of metrics associated with the person is collected from a plurality of different sources.

12. The system of claim 10 wherein the plurality of metrics associated with the person is collected from a plurality of devices associated with the person.

13. The system of claim 12 wherein the plurality of devices include wired or wireless devices compatible with at least one networking technology from the group consisting of: Bluetooth, WiFi, near-field communication (NFC), radio frequency identification (RFID), Ethernet, FireWire, universal serial bus (USB), and Secure Digital (SD) card.

14. The system of claim 10 being further configured to integrate metrics from the person's electronic health record (EHR).

15. The system of claim 10 being further configured to specify a priority or severity corresponding to the notification.

16. The system of claim 10 wherein the plurality of metrics associated with a person is stored in a database at a location proximate to the person.

17. The system of claim 10 being further configured to have periodic communication with a data center via a network data transmission.

18. The system of claim 10 wherein generating the care plan includes generating a medication list, an appointment list, and a set of actions and goals specific to the person's clinical conditions or wellness goals.

19. A non-transitory machine-useable storage medium embodying instructions which, when executed by a machine, cause the machine to:
receive a care plan associated with a person, the care plan including at least one rule defining an action to be performed if at least one of a plurality of metrics is not timely received or if at least one of the plurality of metrics is outside of pre-defined limits;
collect and aggregate the plurality of metrics associated with the person, the plurality of metrics being collected by explicit entry by a user or automatically captured by a sensor associated with the person;
provide support to the person in adhering to the care plan; and
perform the action based on the care plan, the action including automatically sending a notification to at least one of a hierarchy of pre-defined recipients by one or more methods of communication.

20. The machine-useable storage medium of claim 19 wherein the plurality of metrics associated with the person is collected from a plurality of different sources.
